(19) United States
(12) Patent Application Publication
(10) Pub. No.: US 2016/0319626 A1
(43) Pub. Date: Nov. 3, 2016

(54) PLUNGER PACKING NUT WITH INTEGRAL PACKING

(71) Applicant: FORUM US, INC., Houston, TX (US)

(72) Inventor: Mark C. DILLE, Houston, TX (US)

(21) Appl. No.: 15/140,760

(22) Filed: Apr. 28, 2016

Related U.S. Application Data
(60) Provisional application No. 62/155,565, filed on May 1, 2015.

(51) Int. Cl. E21B 33/068; E21B 33/08; F16L 15/04

(52) U.S. Cl. CPC E21B 33/068; F16L 15/04; E21B 33/08

(57) ABSTRACT

A packing nut for a fluid end module for use in a pressurized fluid delivery system. The packing nut includes a nut body having a threaded surface adapted to mate with threads formed in a body of the fluid end module. A recess is formed in the nut body. A packing material is disposed within the recess of the nut body.

### CROSS-REFERENCE TO RELATED APPLICATION

This application claims priority to U.S. Provisional Patent Application Ser. No. 62/155,565, filed May 1, 2015, which is herein incorporated by reference in its entirety.

### BACKGROUND

1. Field

Embodiments disclosed herein relate to a packing nut for a fluid end utilized in high-pressure plunger pumps. More specifically, to a packing nut with an integral packing.

2. Description of the Related Art

Multiplex plunger pumps are commonly used in the oil and gas industry and are well known in the art. These pumps include a fluid end through which fluid flows, and a power end that reciprocates a plunger within the fluid end to both draw fluid into the fluid end and discharge the fluid out of the fluid end. These pumps can pump fluids into a wellbore at rates of up to 10 barrels per minute and at pressures up to 20,000 pounds per square inch (psi).

A fluid end typically includes three or more plunger bores. Each plunger bore houses a reciprocating plunger. The reciprocating plunger is coupled to the fluid end by a packing nut having a packing material that forms a dynamic seal between the reciprocating plunger and the plunger bore in the fluid end. The packing material is disposed between an internal end of the nut and an outward end of the plunger bore.

Conventional packing nuts compress the packing material and do not tighten metal to metal with a seating face in the fluid end plunger bore. Additionally, conventional packing nuts require an external lock that is configured to prevent the packing nut from unthreading and backing out of the fluid end during operation. Further, conventional packing nuts typically do not have seals around the packing nut threads, which create paths through which lubricant can leak out, thereby reducing lubrication efficiency and creating environmental hazards that must be dealt with operationally.

Finally, when packing failure occurs, washout of a seal surface (formed on the plunger bore and against which the packing material seals) is common. The damage to the seal surface typically requires weld repair, machining, or replacement of the fluid end with the damaged seal surface. Repair or replacement of a fluid end is time consuming and costly.

Therefore, there exists a need for a new and improved packing nut that addresses one or more of the drawbacks of conventional packing nuts described above.

### SUMMARY

It is therefore an object of the disclosure to provide a packing nut for a fluid end of a multiplex plunger pump. According to one embodiment, the packing nut includes a nut body having a threaded surface adapted to mate with threads formed in a body of the fluid end, a recess formed in a surface of the nut body, and a packing material disposed within the recess of the nut body.

According to another embodiment, the packing nut includes a nut body having a recess formed in a first end thereof opposite a threaded surface, the threaded surface adapted to mate with threads formed in a body of the fluid end module, and a packing material disposed within the recess of the nut body.

According to another embodiment, the packing nut includes a nut body having an outer surface and an inner surface, the inner surface adapted to contact the body of the fluid end module to form a metal to metal contact therebetween, the nut body further comprising a threaded surface adapted to mate with threads formed in the body of the fluid end module, a recess formed in a surface of the nut body, and a packing material disposed within the recess of the nut body.

### BRIEF DESCRIPTION OF THE DRAWINGS

Having generally described the various embodiments of the disclosure, reference will now be made to the accompanying drawings.

FIG. 1 is a cross-sectional view of a fluid end module showing the internal components thereof.

FIG. 2 is an enlarged cross-sectional view of a packing nut shown in FIG. 1.

To facilitate understanding, identical reference numerals have been used, where possible, to designate identical elements that are common to the figures. It is contemplated that elements disclosed in one embodiment may be beneficially utilized with other embodiments without specific recitation.

### DETAILED DESCRIPTION

Embodiments of the disclosure include a packing nut for a fluid end for use in a pressurized fluid delivery system, such as a multiplex plunger pump. The packing nut, according to the embodiments disclosed herein, may be retrofitted to existing fluid ends of multiplex plunger pumps. The fluid ends may be modular fluid ends having two or more fluid end modules coupled together.

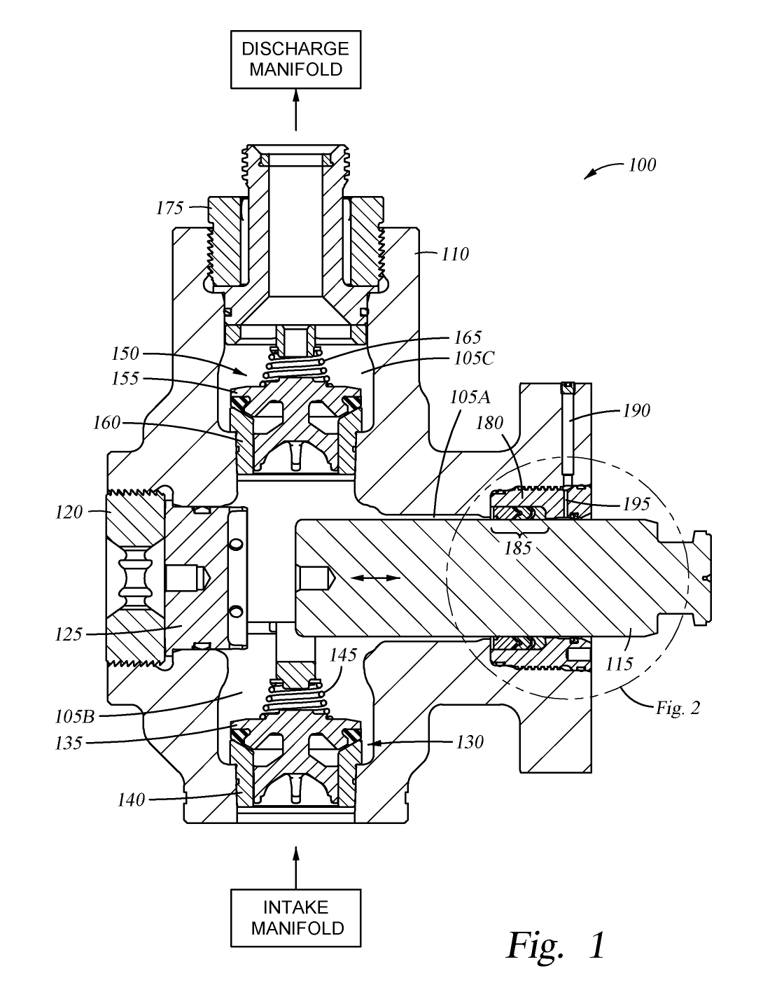

FIG. 1 is a cross-sectional view of one embodiment of a fluid end module 100 showing internal components thereof. A plurality of bores, shown as a plunger bore 105A, an intake bore 1058, and a discharge bore 105C are formed in a body 110 of the fluid end module 100. The body 110 may be forged from a single piece of high tensile strength steel. In one embodiment, the steel is AISI 4330 steel that is heat treated to a yield strength of at least 110 kilopounds per square inch.

A plunger 115 is disposed in one end of the plunger bore 105A. A cover nut 120 and a seal gland 125 are disposed in the other end of the plunger bore 105A. The cover nut 120 and the seal gland 125 can be removed to provide access into the interior of the body 110.

An inlet valve assembly 130 is disposed in the intake bore 105B. The inlet valve assembly 130 includes a valve body 135 biased against a valve seat 140 by a biasing member 145, such as a spring. The inlet valve assembly 130 controls intake of fluid into the body 110 from an intake manifold. An outlet valve assembly 150 is disposed in the discharge bore 105C. The outlet valve assembly 150 includes a valve body 155 biased against a valve seat 160 by a biasing member 165, such as a spring. The outlet valve assembly 150 controls discharge of fluid out of the body 110 to a discharge manifold. A quick connect/disconnect collar 175 may be coupled between the discharge bore 105C and the discharge manifold.

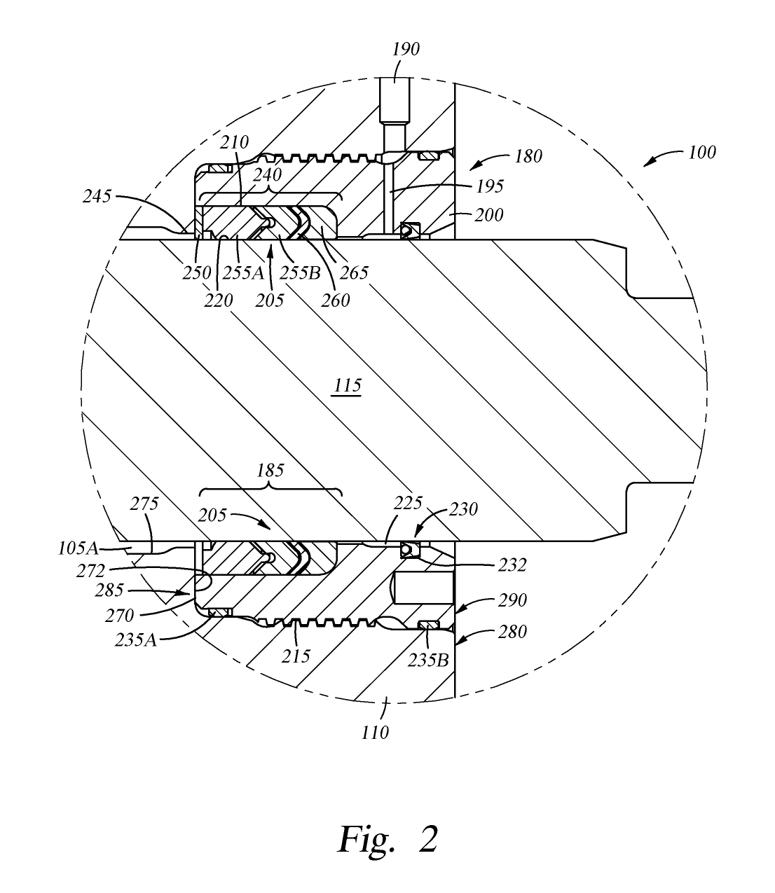

The plunger 115 reciprocates in the plunger bore 105A to pump fluid from the intake manifold into the body 110 and to pump the fluid out of the body 110 to the discharge manifold. A packing nut 180 having a packing material disposed within an integral packing material pocket 185 forms a seal at the interface between the packing nut 180 and the plunger 115. Lubricating fluids from a lubricant source may be supplied to the interface between the packing nut 180 and the plunger 115 via a port 190 formed in the body 110 and a port 195 formed in the packing nut 180. Additional details of the packing nut 180 are described in FIG. 2.

FIG. 2 is an enlarged cross-sectional view of the packing nut 180 shown in FIG. 1. The integral packing material pocket 185 is formed in a nut body 200 of the packing nut 180. The integral packing material pocket 185 of the packing nut 180 includes a recessed surface 210 of the nut body 200 containing packing material 240 that forms a seal 205 between the nut body 200 and a sidewall 220 of the plunger 115. The nut body 200 includes a threaded surface 215 opposing the recessed surface 210. The threaded surface 215 engages with female threads formed in the body 110 of the fluid end module 100 when installed thereon.

The port 195 formed in the nut body 200 supplies lubricating fluid into a charge channel 225 formed at least partially in the nut body 200. A wiper seal 230 may be retained in an interior recess 232 formed in the nut body 200 adjacent to the charge channel 225 to prevent lubricant from leaking out of the nut body 200. On an opposing side of the nut body 200, a primary seal 235A may be disposed at one end of the nut body 200 inward of (e.g. below) the threaded surface 215 to seal against high pressure fluid from plunger bore 105A, and a secondary seal 235B may be disposed at the opposite end of the nut body 220 outward of (e.g. above) the threaded surface 215 to seal against lubricating fluid that may leak past the primary seal 235A along the outside diameter of the nut body 200.

A packing material 240 is disposed in the recessed surface 210 of the packing nut 180 and forms the seal 205 between the recessed surface 210 and the plunger 115. In some embodiments, a junk ring 245, which is typically included as a separate element in conventional packing nuts, is integrally formed with the body 110 of the fluid end module 100. The junk ring 245 is shown as a reduced inner diameter portion (or inner shoulder) formed at an end of the plunger bore 105A adjacent to the packing material 240. The junk ring 245 helps prevent sand and other debris in the plunger bore 105A from flowing into the packing material 240. In some embodiments, the packing material 240 includes one or more of a header ring 250, one or more pressure rings 255A and/or 255B, a thumbnail ring 260, and a female adapter 265 contained within the integral packing material pocket 185.

In some embodiments, a lantern ring, typically included as a separate element in conventional packing nuts, is integrally formed in the nut body 200 as the charge channel 225, which provides a fluid path between the port 195 and the recess 210 through which a lubricating fluid may flow.

In conventional packing nuts, the packing material is disposed within the plunger bore 105A, which increases the possibility of damage to the seal surface at that location in the event of seal failure. However, according to the embodiments disclosed herein, the packing nut 180 retains the packing material 240 within the integral packing material pocket 185. Further, conventional packing nuts do not “bottom out” against the body of the fluid end module, but rather “float” on the packing material, which requires the use of an external locking nut that prevents the packing nut from unthreading and backing out of the body of the fluid end module. However, according to the embodiments disclosed herein, the nut body 200 of the packing nut 180 includes a bottom surface or inner surface 270 that does “bottom out” against and contact a surface 272 of the body 110 of the fluid end module 100 adjacent to the junk ring 245 to form a metal-to-metal contact 285. The friction between the surfaces forming the metal-to-metal contact 285 inhibits rotation of the nut body 200 and thereby prevents unthreading or backing out of the nut body 200 during operation.

The packing nut 180 may be installed by rotating the nut body 200 into a threaded bore of the body 110 of the fluid end module 100 to “bottom out” on an internal metal surface (such as surface 272) of the body 110 to form the metal-to-metal contact 285. The friction between the surfaces forming the metal-to-metal contact 285 requires a suitable amount of torque application to the packing nut 180 to unthread the nut body 200, which prevents the packing nut 180 from inadvertently backing out. The metal-to-metal contact 285 eliminates the need for a separate external locking device to prevent counter-rotation of the packing nut 180. The nut body 200 may also have a length substantially equal to the depth of the threaded bore of the body 110 such that an outer surface 290 of the nut body 200 is substantially coplanar with an outer surface 280 of the body 110 of the fluid end module 100 when installed. The surfaces 280 and 290 being substantially flush with each other provides a visual indication that the packing nut 180 has been properly installed.

The primary seal 235A prevents the high pressure fluid from plunger bore 105A from escaping to atmosphere and the secondary seal 235B prevents leakage of lubricating fluid past the outside diameter of packing nut 180. Additionally, having the packing material 240 disposed within the packing nut 180 eliminates the dynamic seal between the packing material 240 and the plunger bore 105A (as in conventional packing nuts), which can potentially damage the plunger bore 105A of the fluid end module 100. Thus, the embodiments of the packing nut 180 disclosed herein eliminates washout of the plunger bore 105A of the fluid end module 100 due to packing material failure, and leakage of lubricants and high pressure fluids alike.

Seals, such as the packing material 240, the primary seal 235A, the secondary seal 235B, and the wiper seal 230 substantially prevent any leaks through and/or around the nut body 200. In some embodiments, a failure of the packing nut 180 may be determined by a visual inspection of any leakage through and/or around the nut body 200. In the event of a failure, replacement of the packing nut 180 will be less expensive than repair or replacement of fluid end modules using conventional packing nuts.

While the foregoing is directed to embodiments of the disclosure, other and further embodiments of the disclosure thus may be devised without departing from the basic scope thereof, and the scope thereof is determined by the claims that follow.

1. A packing nut for a fluid end module, comprising:
a nut body having a threaded surface adapted to mate with threads formed in a body of the fluid end module;
a recess formed in a surface of the nut body; and
a packing material disposed within the recess of the nut body.

2. The packing nut of claim 1, wherein the packing material further comprises one or more of a header ring and a pressure ring.

3. The packing nut of claim 2, wherein the packing material further comprises a thumbnail ring and a female adapter.

4. The packing nut of claim 1, further comprising a primary seal disposed at one end of the nut body inward of the threaded surface.

5. The packing nut of claim 4, further comprising a secondary seal disposed at an opposite end of the nut body outward of the threaded surface.

6. The packing nut of claim 4, further comprising a wiper seal disposed at an opposite end of the nut body on an interior surface thereof.

7. The packing nut of claim 1, wherein a bottom surface of the nut body engages the body of the fluid end module to form a metal to metal contact.

8. The packing nut of claim 7, wherein an outer surface of the nut body is coplanar with an outer surface of the body of the fluid end module.

9. The packing nut of claim 1, further comprising:
a junk ring integrated with the nut body.

10. A packing nut for a fluid end module, comprising:
a nut body having a recess formed in a first end thereof opposite a threaded surface, the threaded surface adapted to mate with threads formed in a body of the fluid end module; and
a packing material disposed within the recess of the nut body.

11. The packing nut of claim 10, wherein the packing material further comprises one or more of a header ring, a pressure ring, a thumbnail ring and a female adapter.

12. The packing nut of claim 10, further comprising a primary seal disposed at the first end of the nut body inward of the threaded surface.

13. The packing nut of claim 12, further comprising a secondary seal disposed at a second end of the nut body outward of the threaded surface.

14. The packing nut of claim 10, further comprising a wiper seal disposed at a second end of the nut body on an interior surface thereof.

15. The packing nut of claim 10, wherein a bottom surface of the nut body engages the body of the fluid end module to form a metal to metal contact.

16. A packing nut for a body of a fluid end module, comprising:
a nut body having an outer surface and an inner surface, the inner surface adapted to contact the body of the fluid end module to form a metal to metal contact therebetween, the nut body further comprising:
a threaded surface adapted to mate with threads formed in the body of the fluid end module;
a recess formed in a surface of the nut body; and
a packing material disposed within the recess of the nut body.

17. The packing nut of claim 16, wherein the packing material further comprises one or more of a header ring, a pressure ring, a thumbnail ring and a female adapter.

18. The packing nut of claim 16, further comprising a primary seal disposed adjacent to the inner surface of the nut body inward of the threaded surface.

19. The packing nut of claim 18, further comprising a secondary seal disposed adjacent to the outer surface of the nut body outward of the threaded surface.

20. The packing nut of claim 16, further comprising a wiper seal disposed adjacent to the outer surface of the nut body on an interior surface thereof.
